(19) United States
(12) Patent Application Publication
(10) Pub. No.: US 2026/0176453 A1
(43) Pub. Date: Jun. 25, 2026

(54) COMPOSITE MATERIALS AND METHODS FOR PREPARING THE SAME WITH LATENT ACID CATALYSTS

(71) Applicant: Neenah, Inc., Alpharetta, GA (US)

(72) Inventors: Peter J. Veverka, Munising Mill, MI (US); Richard E. Kajander, Munising Mill, MI (US); Julie M. Tomasi, Munising Mill, MI (US)

(21) Appl. No.: 19/411,763

(22) Filed: Dec. 8, 2025

Related U.S. Application Data
(60) Provisional application No. 63/736,647, filed on Dec. 20, 2024.

(51) Int. Cl. C08L 13/02; C08K 3/28; C08L 9/08; D06M 15/233; D06M 15/263; D21H 17/35; D21H 17/43

(52) U.S. Cl. CPC C08L 13/02; C08K 3/28; C08L 9/08; D06M 15/233; D06M 15/263; D21H 17/35; D21H 17/43; C08L 2312/00

(57) ABSTRACT

Composite materials, such as polymer reinforced textiles and polymer reinforced papers, and methods for the same are described. The polymer reinforced materials may include a base and a crosslinked latex polymer disposed on the base. The base may include one or more layers, and each of the one or more layers may include a plurality of fibers. The crosslinked latex polymer may be prepared from a saturating composition including an aqueous solvent, a curable latex polymer, and an accelerant. The accelerant may include a latent acid catalyst. The crosslinked latex polymer may be prepared by crosslinking the curable latex polymer with the latent acid catalyst.

### CROSS-REFERENCE TO RELATED APPLICATIONS

This application claims the benefit of U.S. Provisional Application Ser. No. 63/736,647, filed Dec. 20, 2024, the complete disclosure of which is incorporated herein by reference in its entirety for all purposes.

### TECHNICAL FIELD

This following description generally relates to composite materials, such as polymer reinforced textiles, and methods for preparing the same.

### BACKGROUND

Conventional polymer reinforced materials, such as polymer reinforced textiles, are often utilized to prepare a wide variety of products due in part to the unique properties, such as their strength, durability, and ability to withstand mechanical stresses. For example, polymer reinforced materials, such as polymer reinforced textiles, may often be utilized for the preparation of abrasive products (e.g., sandpaper) and creped layers for varying purposes. Conventional methods for preparing or fabricating the polymer reinforced materials may include preparing a base (e.g., paper making, textile, paper, etc.), saturating the base with a saturating composition including a polymer, and aging the saturated base to cure or crosslink the polymer of the saturating composition to thereby fabricate the polymer reinforced materials. While conventional methods for fabricating the polymer reinforced materials are generally effective, recent trends have been directed to providing more cost-effective methods for fabricating the polymer reinforced materials while maintaining or improving the properties (e.g., mechanical strength) thereof.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a composite material. The composite material may include a base and a crosslinked latex polymer disposed on the base. The base may include one or more layers. The crosslinked latex polymer may be prepared from a saturating composition including an aqueous solvent, a curable latex polymer, and an accelerant. The accelerant may include a latent acid catalyst.

In embodiments, the crosslinked latex polymer may be prepared by crosslinking the curable latex polymer with the latent acid catalyst.

In one aspect, the saturating composition may further include a crosslinker. The crosslinker may be present in an amount of from about 0.1 wt. % to about 10 wt. %, or about 0.5 wt. % to about 5 wt. %, or about 1 wt. % to about 3 wt. %, or about 2 wt. % to about 2.5 wt. % based on the total dry weight of the saturating composition.

In one aspect, the latent acid catalyst may be configured to facilitate the formation of crosslinks between respective carboxyl functional groups of each of the plurality of polymer chains.

In one aspect, the latent acid catalyst may include an ammonium salt. Suitable ammonium salts include, but are not limited to, ammonium chloride, ammonium carbonate, ammonium nitrate, ammonium acetate, ammonium bicarbonate, ammonium sulfate, ammonium bromide, ammonium fluoride, ammonium dichromate, ammonium phosphate, ammonium oxalate, and ammonium thiocyanate and combinations thereof.

In one aspect, the ammonium salt comprises ammonium oxalate.

In one aspect, the latent acid catalyst may be present in an amount of from about 0.1 wt. % to about 10 wt. %, or about 0.5 wt. % to about 5 wt. %, or about 1 wt. % to about 3 wt. %, or about 2 wt. % to about 2.5 wt. % based on the total dry weight of the saturating composition.

In one aspect, the curable latex polymer may include any suitable cross linkable latex polymer. Suitable polymers include, but are not limited to, polyvinyl acetate latex, a nitrile butadiene rubber (NBR) latex, a styrene butadiene rubber (SBR) latex, acrylic latex, styrene acrylic latex, or a combination thereof.

In embodiments, the curable latex polymer comprises a nitrile butadiene rubber (NBR) latex.

In embodiments, the curable latex polymer comprises a styrene butadiene rubber (SBR) latex.

In embodiments, the curable latex polymer further comprises a styrene acrylic latex.

In an exemplary embodiment, the curable latex polymer comprises styrene acrylic latex in about 10 wt. % to about 30 wt. % of the saturating composition, or about 15 wt. % to about 25 wt. % of the saturating composition, or about 20 wt. % to about 22 wt. % of the saturating composition (i.e., about 25 parts out of 120 total parts of the saturating composition). The curable latex polymer further comprises a styrene butadiene rubber (SBR). in about 50 wt. % to about 90 wt. % of the saturating composition, or about 60 wt. % to about 80 wt. % of the saturating composition, or about 60 wt. % to about 65 wt. % of the saturating composition (i.e., about 75 parts out of a total of 120 parts of the saturating composition). Applicant has discovered that a higher weight percentage of SBR provides improved water resistance.

In embodiments, the saturating composition may include additional additives. The additional additives may be present in the saturating composition in about 10 wt. % to about 20 wt. %. In an exemplary embodiment, the additional additives include a styrene maleic anhydride (SMA).

In one aspect, the composite material may include a machine direction wet tensile strength of from about 5 kilograms/15 millimeters (kg/15 mm) to about 10 kg/15 mm, or about 6 kilograms/15 millimeters to about 9 kilograms/15 millimeters, or about 7 kilograms/15 millimeters.

In one aspect, the crosslinked latex polymer may be prepared by activating the latent acid catalyst to release an acid species, and crosslinking the curable latex polymer with the acid species from the latent acid catalyst.

In one aspect, activating the latent acid catalyst to release the acid species may include drying the saturating composition such that the saturating composition may include less than or equal to about 40 wt. %, or less than about 35 wt. %, or less than about 30 wt. % or less than about 20 wt. %, or less than about 15 wt. %, or less than about 10 wt. % or less than about 5 wt. % of the aqueous solvent, based on the total weight of the composite material.

In one aspect, crosslinking the curable latex polymer may not include thermal aging.

In one aspect, crosslinking the curable latex polymer may not include online thermal aging.

In one aspect, crosslinking the curable latex polymer may not include offline thermal aging.

In one aspect, crosslinking the curable latex polymer may include offline thermal aging.

In one aspect, the base may include a basis weight from about to 50 gsm to about 200 gsm, or about 80, gsm, about 95 gsm, about 100 gsm, about 110 gsm, about 115 gsm, about 120 gsm, about 125 gsm, about 140 gsm, about 150 gsm, about 160 gsm about 170 gsm, about 180 gsm, or about 200 gsm. The base may have a thickness of from about 0.05 mm to about 1 mm, or about 0.05 to about 0.5 mm, or about 0.25 mm.

In one aspect, the curable latex polymer may include a plurality of polymer chains. Each of the plurality of polymer chains may include a plurality of carboxyl functional groups.

In one aspect, the composite material may include a machine direction dry tensile strength of from about 10 kilograms/15 millimeters (kg/15 mm) to about 15 kg/15 mm.

In one aspect, the composite material may include ratio of wet tensile strength to dry tensile strength of greater than or equal to about 50%, or greater than or equal to about 60\hat{ } or greater than or equal to about 65%.

In one aspect, the saturating composition may further include a film forming resin.

In one aspect, the film forming resin may include one or more styrene maleic anhydride (SMA) polymers.

The foregoing and/or other aspects and utilities described herein may be achieved by providing a composite material. The composite material may include a base and a crosslinked latex polymer disposed on the base. The composite material may be prepared by disposing a saturating composition on the base, where the saturating composition includes an aqueous solvent, a curable latex polymer, and an accelerant, and where the accelerant may include a latent acid catalyst; drying the saturating composition disposed on the base to activate the accelerant to release an acid species; and crosslinking the curable latex polymer with the acid species to prepare the composite material.

In one aspect, the saturating composition may further include a crosslinker.

In one aspect, drying the saturating composition may include drying the saturating composition to less than or equal to about 15 wt. % to about 40 wt. % of the aqueous solvent, based on the total weight of the composite material.

In one aspect, crosslinking the curable latex polymer with the acid species may not include thermal aging.

In one aspect, crosslinking the curable latex polymer with the acid species may not include online thermal aging.

In one aspect, crosslinking the curable latex polymer with the acid species may not include offline thermal aging.

In one aspect, crosslinking the curable latex polymer with the acid species may include offline thermal aging.

In one aspect, the base may include a conditioned basis weight from about to 50 gsm to about 200 gsm, or about 80, gsm, about 95 gsm, about 100 gsm, about 110 gsm, about 115 gsm, about 120 gsm, about 125 gsm, about 140 gsm, about 150 gsm, about 160 gsm about 170 gsm, about 180 gsm, or about 200 gsm. The base may have a thickness of from about 0.05 mm to about 1 mm, or about 0.05 to about 0.5 mm, or about 0.25 mm.

In one aspect, the curable latex polymer may include a styrene acrylic latex, a nitrile butadiene rubber (NBR) latex, a styrene butadiene rubber (SBR) latex, or a combination thereof.

In one aspect, the curable latex polymer may include a plurality of polymer chains, each of the plurality of polymer chains comprising a plurality of carboxyl functional groups.

In one aspect, the latent acid catalyst may be configured to facilitate the formation of crosslinks between respective carboxyl functional groups of each of the plurality of polymer chains.

In one aspect, the latent acid catalyst may include an ammonium salt.

In one aspect, the ammonium salt may include ammonium oxalate.

In one aspect, wherein the accelerant may be present in an amount of from about 0.1 wt. % to about 10 wt. %, or about 0.5 wt. % to about 5 wt. % or about 1 wt. %, based on the total dry weight of the saturating composition.

In one aspect, the composite material may include a machine direction wet tensile strength of from about 5 kilograms/15 millimeters (kg/15 mm) to about 10 kg/15 mm, or about 6 kilograms/15 millimeters to about 9 kilograms/15 millimeters, or about 7 kilograms/15 millimeters.

In one aspect, the composite material may include a machine direction dry tensile strength of from about 10 kilograms/15 millimeters (kg/15 mm) to about 15 kg/15 mm.

In one aspect, the composite material may include ratio of wet tensile strength to dry tensile strength of greater than or equal to about 50%, or greater than or equal to about 60\hat{ } or greater than or equal to about 65%.

In one aspect, the saturating composition further may include a film forming resin.

In one aspect, the film forming resin may include one or more styrene maleic anhydride (SMA) polymers.

The foregoing and/or other aspects and utilities described herein may be achieved by providing a composite material. The composite material may include a base and a crosslinked latex polymer disposed on the base. The base may include one or more layers, each of the one or more layers may include a plurality of fibers. The crosslinked latex polymer may include a reaction product of a curable latex polymeric binder and an acid species derived from a latent acid catalyst.

In one aspect, the latent acid catalyst may include an ammonium salt.

In one aspect, the latent acid catalyst may include ammonium oxalate, and wherein the acid species may include oxalic acid.

In one aspect, the oxalic acid may facilitate the crosslinking of the plurality of polymer chains with one another.

In one aspect, the composite material may include a machine direction wet tensile strength of from about 5 kilograms/15 millimeters (kg/15 mm) to about 10 kg/15 mm.

In one aspect, the composite material may include a machine direction dry tensile strength of from about 10 kilograms/15 millimeters (kg/15 mm) to about 15 kg/15 mm.

In one aspect, the composite material may include ratio of wet tensile strength to dry tensile strength of greater than or equal to about 50% or greater than or equal to about 60\hat{ } or greater than or equal to about 65%.

In one aspect, the composite material may be prepared without online thermal aging.

The foregoing and/or other aspects and utilities described herein may be achieved by providing an abrasive product including any of the composite material described herein.

In one aspect, the abrasive product may be sandpaper.

The foregoing and/or other aspects and utilities described herein may be achieved by providing a durable label including any of the composite material described herein.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

Composite materials and methods for the same are described. The composite materials may be or include, but are not limited to, polymer reinforced textiles, polymer reinforced layers, polymer reinforced composites, polymer reinforced articles, polymer reinforced papers, or the like, or any combination thereof. The polymer reinforced materials may form a portion of or may be utilized in the preparation or fabrication of a creped sheet; an abrasive structure, such as sandpaper, a sanding disc, or a backer for an abrasive; a durable label, such as a label on jeans, or the like, or any combination thereof. The polymer reinforced materials may include a base (e.g., base textile) and a polymeric system (e.g., saturating composition or solution). The base may be a textile, a sheet, an article, a composite, a paper, or the like, or any combination thereof. The base may be coated, mixed, or otherwise contacted with the polymeric system. In at least one implementation, the polymer reinforced materials may be prepared without aging (e.g., online aging). As used herein, the term “aging” may include heating for a predetermined temperature and/or time to crosslink and/or cure a polymer of the polymeric system. As used herein, the term “crosslink,” “crosslinking,” or the like, refers to the formation of bridges or chemical bonds (e.g., covalent bonds) between two polymer molecules or chains that results in a network-like (e.g., 3-dimensional network) structure. As used herein, the term “cure,” “curing,” or the like, refers to a process by which a polymer may solidify or harden. Curing may include crosslinking, evaporation of solvents, or one or more chemical reactions. It should be appreciated that while curing may include crosslinking, curing may also include other processes, such as solvent evaporation. As further discussed herein, the polymer reinforced materials described may exhibit the same (e.g., parity), substantially the same, or improved properties (e.g., wet and/or dry tensile strength) as compared to polymer reinforced materials with or exposed to aging.

The base may include one or more layers or plies. For example, the base may include a single sheet or ply. In another example, the base may include a plurality of layers or plies disposed adjacent to one another. The plurality of layers or plies disposed adjacent to one another may be coupled with one another. Each of the one or more layers may include a plurality of fibers. The plurality of fibers in any one or more of the layers may be woven or nonwoven. For example, any one or more of the layers may be nonwoven layers of fibers or woven layers of fibers. The one or more layers may be isotropic or anisotropic. For example, the plurality of fibers may be multi-directionally disposed such that the sheet prepared therefrom may be isotropic. In another example, the plurality of fibers may be aligned or substantially aligned with one another (e.g., substantially unidirectional) such that the sheet prepared therefrom may be anisotropic. The direction that the plurality of fibers of an anisotropic sheet may be disposed or oriented may be referred to as a machine direction (MD), or the direction that the plurality of fibers are oriented as they are directed into a machine, device, or system. The direction normal to the machine direction (MD) may be referred to as the cross-machine direction (CD).

In at least one implementation, the base includes a plurality of layers. Each of the plurality of layers may include anisotropic layers including the plurality of fibers that may be substantially unidirectionally aligned with one another. A first sheet of the base may be disposed such that the plurality of fibers thereof may be oriented in a first direction, and a second sheet disposed adjacent the first sheet may be disposed such that the plurality of fibers thereof may be oriented in a second direction rotationally offset from the first direction. The rotational offset between the first and second direction may be from about 1° to about 90°.

The plurality of fibers may be or include one or more natural polymers, one or more synthetic polymers, or a combination thereof. For example, the plurality of fibers may include natural fibers (e.g., cellulose fibers), synthetic fibers (e.g., fibers prepared from synthetic polymer(s)), or a combination thereof. In at least one implementation, the plurality of fibers of any one or more of the layers may include a combination of cellulose fibers and synthetic fibers. Any one or more of the layers of the base may include the natural fibers in an amount of from about 0 wt % to about 100 wt %. For example, any one or more of the layers of the base may include the natural fibers in an amount of from about 0 wt %, about 10 wt %, about 20 wt %, about 30 wt %, about 40 wt %, about 50 wt %, about 60 wt %, about 70 wt %, about 80 wt %, about 90 wt %, or about 100 wt %, based on the total dried weight of the sheet. Any one or more of the layers of the base may include the synthetic fibers in an amount of from about 0 wt % to about 100 wt %. For example, any one or more of the layers of the base may include the synthetic fibers in an amount of from about 0 wt %, about 10 wt %, about 20 wt %, about 30 wt %, about 40 wt %, about 50 wt %, about 60 wt %, about 70 wt %, about 80 wt %, about 90 wt %, or about 100 wt %, based on the total dried weight of the sheet. Any one or more of the layers of the base may have a weight ratio of the natural fibers to the synthetic fibers of from about 10:1 (i.e., about 10 to about 1), about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, or about 1:10.

The natural polymers may be or include, but are not limited to, cellulose or cellulosic polymers. For example, the natural fibers may be or include, but are not limited to, cellulose or cellulosic fibers. As used herein, the term “cellulosic” refers to a polysaccharide composed of glucose units. The cellulose fibers may be prepared from or include pulp obtained by any conventional pulping process, such as mechanical, chemi-mechanical, semichemical, and chemical processes.

As used herein, the term or expression “synthetic polymer” may refer to any polymer that does not occur naturally in the form utilized. Illustrative synthetic polymers may be or include, but are not limited to, one or more of a polyolefin, a polytetrafluoroethylene, a polyester, a polyvinyl acetate, a polyvinyl chloride acetate, a polyvinyl butyral, an acrylic resin, a polyamide, a polyvinyl chloride, a polyvinylidene chloride, a polystyrene, a polyvinyl alcohol, a polyurethane, a thermoplastic, a polylactic acid, end-capped polyacetals, acrylic polymers, fluorocarbon polymers, polyamides, polyaramides, polyaryl ethers, polyaryl sulfones, polycarbonates, polyesters, polyaryl sulfides, polyimides, polyolefins, vinyl polymers, diene polymers, polystyrenes, copolymers thereof, or the like, or any combination thereof. As used herein, the term “thermoplastic” refers to any material formed from a polymer which softens and flows when heated above its softening point and/or melting point; such a polymer may be heated and softened a number of times without suffering any basic alteration in characteristics, provided the heating is below the decomposition temperature of the polymer. For example, the synthetic polymers of the plurality of fibers may be or include, but are not limited to, one or more of polyethylene, polypropylene, polybutylene, polyethylene terephthalate, polyacrylate, polymethacrylate, polymethylmethacrylate, nylon 6, nylon 6/6. nylon 4/6, nylon 11, nylon 12, nylon 6/10, and nylon 12/12, end-capped polyacetals, such as poly(oxy-methylene) or polyformaldehyde, poly(trichloroacetaldehyde), poly(n-valeraldehyde), poly(acetaldehyde), and poly(propionaldehyde); acrylic polymers, such as polyacrylamide, poly(acrylic acid), poly(methacrylic acid), poly(ethyl acrylate), and poly(methyl methacrylate); fluorocarbon polymers, such as poly(tetrafluoroethyl-ene), perfluorinated ethylene-propylene copolymers, ethylene-tetrafluoroethylene copolymers, poly(chloro-trifluoroethylene), ethylene-chlorotrifluoroethylene copolymers, poly(vinylidene fluoride), and poly(vinyl fluoride); polyamides, such as poly(6-aminocaproic acid) or poly(ε-caprolactam), poly(hexamethylene adipamide), poly-(hexamethylene sebacamide), and poly(l 1-aminoundecanoic acid); polyaramides, such as poly(imino-1,3-phenyleneiminoisophthaloyl) or poly(m-phenylene isophthalamide); parylenes, such as poly-p-xylylene and poly(chloro-p-xylylene); polyaryl ethers, such as poly(oxy-2,6-dimethyl-1,4-phenylene) or poly(p-phenylene oxide); polyaryl sulfones, such as poly(oxy-1,4-phenylenesulfonyl-1,4-phenyleneoxy-1,4-phenylene-isopropylidene-1,4-phenylene) and poly(sulfonyl-1,4-phenyleneoxy-1,4-phenylenesulfonyl-4,4′-biphenylene); polycarbonates, such as poly(bisphenol A) or poly(carbonyidioxy-1,4-phenyl-eneisopropylidene-1,4-phenylene); polyesters, such as poly(ethylene terephthalate), poly(tetramethylene terephthalate), and poly(cyclo-hexylene-1,4-dimethylene terephthalate) or poly(oxymethylene-1,4-cyclohexylene-methyleneoxyterephthaloyl); polyaryl sulfides, such as poly(p-phenylene sulfide) or poly(thio-1,4-phenylene); polyimides, such as poly(pyromellitimido-1,4-phenylene); polyolefins, such as polyethylene, polypropylene, poly(l-butene), poly(2-butene), poly(l-pentene), poly(2-pentene), poly(3-methyl-1-pentene), and poly(4-methyl-1-pentene); vinyl polymers, such as poly(vinyl acetate), poly(vinylidene chloride), and poly(vinyl chloride); diene polymers, such as 1,2-poly-1,3-butadiene, 1,4-poly-1,3-butadiene, polyisoprene, and polychloroprene; polystyrenes; copolymers of the foregoing, such as acrylonitrile-butadiene-styrene (ABS) copolymers, or the like, or any combination thereof. In an exemplary implementation, the synthetic polymer may include polyester. For example, the synthetic fibers may be or include polyester fibers.

The base may be prepared by mixing, combining, or otherwise contacting the cellulose fibers and the synthetic fibers with one another to form a fibrous mixture. The fibrous mixture may be disposed in a conventional papermaking fiber stock prep beater or pulper including a liquid, such as water, to prepare a fibrous mixture stock. The fibrous mixture stock may be agitated to form or prepare a suspension. The fibrous mixture stock or the suspension may be subjected to one or more refinement steps or processes to improve one or more properties of the base, such as the tensile strength and/or porosity properties of the base. The suspension may be utilized to prepare a fibrous web or the base via conventional papermaking techniques. For example, the base may be formed by distributing the suspension onto a forming surface (e.g., wire), removing water from the distributed suspension, and drying to form the base.

In at least one implementation, one or more additives may be added to the fibrous mixture during formation of the base or after formation of the base (e.g., after drying). For example, wet-strength agents may be used to improve the strength properties of the fibrous web during formation. The wet-strength agents may be present in an amount of from about 0.001 wt. % to about 5 wt. % or about 0.01 wt. % to about 2 wt %, based on the dry weight of the base. The wet strength agents may be or include water soluble, cationic oligomeric or polymeric resins capable of bonding with the cellulosic fibers. Illustrative wet-strength agents may include, but are not limited to, one or more of polyamine-epichlorohydrin, polyamide epichlorohydrin, polyamide-amine epichlorohydrin resins (collectively “PAE” resins), or the like, or any combination thereof. Examples of these materials are described in U.S. Pat. No. 3,700,623 to Keim and U.S. Pat. No. 3,772,076 to Keim, the contents of which are incorporated herein in their entirety by reference thereto for all purposes. Suitable PAE resins are commercially available from Ashland, Inc. under the designation “KYMENE®” (e.g., KYMENER 913A), KYMENER 913A, for example, is believed to be a polyamide epichlorohydrin polymer that contains both cationic sites, which may form ionic bonds with anionic groups on the pulp fibers, and azetidinium groups, which may form covalent bonds with carboxyl groups on the pulp fibers and crosslink with the polymer backbone when cured. Other suitable polyamide-epichlorohydrin resins are described in U.S. Pat. No. 3,885,1.58 to Petrovich; U.S. Pat. No. 3,899,388 to Petrovich; U.S. Pat. No. 4,129,528 to Petrovich; U.S. Pat. No. 4,147,586 to Petrovich; and U.S. Pat. No. 4,222,921 to Van Eanam, the contents of which are incorporated herein in their entirety by reference thereto for all purposes. Illustrative wet strength agents may also include dialdehyde starch, polyethylene imine, mannogalactan gum, glyoxal, dialdehyde mannogalactan, water-soluble polyacrylamide resins available from Cytec Industries, Inc. of West Patterson, N.J. under the designation PAREZ® (e.g., PAREZ® 631NC), or the like, or any combination thereof. It should be appreciated that PAREZ® resins are formed from a polyacrylamide-glyoxal polymer that contains cationic hemiacetal sites. These sites may form ionic bonds with carboxyl or hydroxyl groups present on the cellulosic fibers to provide increased strength to the web. Because the hemiacetal groups are readily hydrolyzed, the wet strength provided by the resins is primarily temporary. Such resins are believed to be described in U.S. Pat. No. 3,556,932 to Coscia, et al. and U.S. Pat. No. 3,556,933 to Williams, et al., the contents of which are incorporated herein in their entirety by reference thereto for all purposes.

The base may have a conditioned basis weight of from about 50 grams per square meter (gsm) to about 200 gsm. For example, the base may have a basis weight of from about 80, gsm, about 95 gsm, about 100 gsm, about 110 gsm, about 115 gsm, about 120 gsm, about 125 gsm, about 140 gsm, about 150 gsm, about 160 gsm about 170 gsm, about 180 gsm, or about 200 gsm. The base may have a thickness of from about 0.05 mm to about 1 mm, or about 0.05 to about 0.5 mm, or about 0.25 mm. as measured according to any one or more reference tests of the Technical Association of the Pulp and Paper Industry, Inc. (TAPPI), such as TAPPI test method T411.

The polymeric system, which may also be referred to as a saturating composition or saturating solution, may include a solvent (e.g., water), and one or more latex polymers or curable latex polymeric binders, one or more crosslinkers, one or more accelerants, or any combination thereof. In an exemplary implementation, the polymeric system includes the solvent and a combination of one or more curable latex polymeric binders, one or more crosslinkers, and one or more accelerants dispersed, dissolved, mixed, or otherwise combined with the solvent. The polymeric system may be an aqueous solution having a pH greater than or equal to about 7. For example, the polymeric system may have a pH of from greater than or equal to about 7 to less than or equal to about 10. In an exemplary implementation, the polymeric system may have a pH of from about 7 to about 10, about 7.5 to about 9.5, or about 8 to about 9.

As used herein, the term “latex polymer” or “curable latex polymeric binder” refers to an emulsion of one or more polymers or a colloidal dispersion of one or more polymers or polymer particles in a solvent (e.g., water). The curable latex polymeric binder may generally be capable of or configured to cure and/or crosslink upon application or exposure to heat, pressure, drying, one or more chemical agents (e.g., catalysts, accelerants, crosslinkers, etc.), or any combination thereof. Curing the latex polymeric binder may include evaporating the solvent of the polymeric system or the curable latex polymeric binder thereof. Curing the latex polymeric binder may also include drying the polymeric system or the curable latex polymeric binder thereof. Curing may further include drying the polymeric system or the curable latex polymeric binder thereof to less than or equal to about 5% moisture/water, less than or equal to about 4% moisture/water, less than or equal to about 3% moisture/water, less than or equal to about 2% moisture/water, less than or equal to about 1% moisture/water, less than or equal to about 0.5% moisture/water, or less than or equal to about 0.1% moisture/water. Curing the curable latex polymeric binder may solidify and/or harden the curable latex polymeric binder into a durable, elastic material. Crosslinking the curable latex polymeric binder may provide a latex polymeric binder having bridges or crosslinks between respective polymer chains of the polymeric binder. Crosslinking the curable latex polymeric binder may provide a 3-dimensional (3D) structure.

Illustrative curable latex polymeric binders may be or include, but are not limited to, one or more of polyacrylates including polymethacrylates, poly(acrylic acid), poly(methacrylic acid), and copolymers of the various acrylate and methacrylate esters and the free acids; styrene-butadiene copolymers; styrene-butadiene rubber (SBR) latex; ethylene-vinyl acetate copolymers; nitrile rubbers or acrylonitrile-butadiene copolymers; nitrile butadiene rubber (NBR) latex; poly(vinyl chloride); poly(vinyl acetate); ethylene-acrylate copolymers; vinyl acetate-acrylate copolymers; neoprene rubbers or trans-1,4-polychloroprenes; cis-1,4-polyisoprenes; butadiene rubbers or cis- and trans-1,4-polybutadienes; ethylene-propylene copolymers, copolymers thereof, or the like, or any combination thereof. Illustrative curable latex polymeric binders may also be found in US Patent Publication No. 2015/0306739, the contents of which are incorporated herein to the extent consistent with the present application. In an exemplary implementation, the curable latex polymeric binder includes NBR latex, SBR latex and a styrene acrylic latex or a combination thereof.

In embodiments, the curable latex polymer comprises a nitrile butadiene rubber (NBR) latex.

In embodiments, the curable latex polymer comprises a styrene butadiene rubber (SBR) latex.

In embodiments, the curable latex polymer further comprises a styrene acrylic latex. In an exemplary embodiment, the curable latex polymer comprises styrene acrylic latex in about 10 wt. % to about 30 wt. % of the saturating composition, or about 15 wt. % to about 25 wt. % of the saturating composition, or about 20 wt. % to about 22 wt. % of the saturating composition (i.e., about 25 parts out of 120 total parts of the saturating composition). The curable latex polymer further comprises a styrene butadiene rubber (SBR). in about 50 wt. % to about 90 wt. % of the saturating composition, or about 60 wt. % to about 80 wt. % of the saturating composition, or about 60 wt. % to about 65 wt. % of the saturating composition (i.e., about 75 parts out of a total of 120 parts of the saturating composition). Applicant has discovered that a higher weight percentage of SBR provides improved water resistance.

In at least one implementation, the curable latex polymeric binders may include one or more functional or functionalized groups. The functional groups may be capable of or configured to facilitate the curing and/or crosslinking of the curable latex polymeric binders. For example, the functional groups of the curable latex polymeric binders may include, but are not limited to, one or more of carboxyl groups, amine groups, pyridyl groups, or the like, or any combination thereof. Without being bound by theory, it is believed that the foregoing functional groups may facilitate the curing and/or crosslinking of the curable latex polymeric binders via the presence of the polar groups thereof. In an exemplary implementation, the curable latex polymeric binder and the polymer chains or molecules thereof may include at least the carboxyl functional groups.

As discussed above, the curable latex polymeric binders may be a colloidal dispersion or emulsion in a solvent. In at least one implementation, the solvent may be an aqueous solvent, such as water. The curable latex polymeric binders may have a solids content (e.g., polymer) of from greater than 0 wt % to less than or equal to about 70 wt %, based on the total weight of the curable latex polymeric binders. For example, the curable latex polymeric binders may have a solids content of from greater than 0 wt %, about 5 wt %, about 10 wt %, about 15 wt %, about 20 wt %, about 25 wt %, about 30 wt %, or about 35 wt % to about 40 wt %, about 45 wt %, about 50 wt %, about 55 wt %, about 60 wt %, about 65 wt %, or about 70 wt %, based on the total weight of the curable latex polymeric binders.

In at least one implementation, the polymeric system may include one or more crosslinkers or crosslinking agents capable of or configured to facilitate or promote the curing and/or crosslinking of the polymeric system and/or the curable latex polymeric binders thereof. For example, the one or more crosslinkers may be capable of or configured to promote the formation of covalent bonds between polymer chains of the polymeric system or the curable latex polymeric binders thereof. Illustrative crosslinkers may be or include, but are not limited to, one or more sulfur compounds, peroxides, metal oxides (e.g., zinc oxide, magnesium oxide, etc.), amines (e.g., hexamethylenediamine, ethylenediamine, etc.), acrylic monomers (e.g., acrylates, methacrylates, etc.), epoxy-functionalized crosslinkers, isocyanates, epoxides, aziridines, melamine-formaldehyde resins, urea-formaldehyde resins, glyoxal and/or derivatives thereof, carbodiimides, imidazolidones, carbamates, or the like, or any combination thereof. In an exemplary implementation, the crosslinker may include one or more of an epoxy resin, an aziridine crosslinker, or any combination thereof. The epoxy resin may be a bisphenol A epoxy resin that may have a solids content of about 60 wt % to about 62 wt %, as measured according to reference test ASTM-D1259 of the American Society for Testing and Materials (ASTM). For example, the epoxy resin may be EPI-REZ™ Resin 3510-W-60, which is commercially available from Westlake Corporation of Houston, TX. The aziridine crosslinker may be a polyfunctional aziridine. The polyfunctional aziridine may be an ethylene imine based tri-functional poly aziridine with a functionality of 3.3, such as pentaerythritol tris(3-(1-aziridinyl) propionate) (PZ-33; CAS: 57116-45-7).

The one or more crosslinkers may be present in the polymeric system in an amount of from greater than 0 wt % to about 10 wt %, based on the total weight of the polymeric system. For example, the one or more crosslinkers may be present in the polymeric system in an amount of from greater than 0 wt %, about 2 wt %, about 4 wt %, or about 5 wt % to about 6 wt %, about 8 wt %, or about 10 wt %, based on the total weight of the polymeric system. In an exemplary implementation, the crosslinker may be present in an amount of from about 1 wt % to about 5 wt %, about 2 wt % to about 4 wt %, or about 3 wt %, based on the total weight of the polymeric system. It should be appreciated that the amount of the crosslinker may be determined, at least in part, on the amount of carboxyl groups or the degree of carboxylation of the curable latex polymeric binder.

The polymeric system may include one or more accelerants. The one or more accelerants may be or include, but are not limited to, one or more latent acid catalysts or the like. As used herein, the term or expression “latent acid catalyst” or the like refers to a chemical substance, compound, or catalyst that remains inactive or non-reactive under certain conditions and becomes active (e.g., releasing acid) when triggered, activated, or stimulated by a specific stimulus or event (e.g., heat, light, contact with water, drying, etc.). The latent acid catalyst may be capable of or configured to release protons (H⁺ ions) or acid species that may catalyze one or more chemical reactions. For example, the latent acid catalyst may be capable of or configured to release protons or acid species to catalyze or facilitate curing and/or crosslinking of the polymeric system or the curable latex polymeric binder thereof. The one or more accelerants may be capable of or configured to catalyze curing and/or crosslinking with or without the one or more crosslinkers. The one or more accelerants may be capable of or configured to reduce the time and/or temperature for curing and/or crosslinking the curable latex polymeric binder. In at least one implementation, the latent acid catalyst may be capable of or configured to release acid species upon drying of the polymeric system. For example, removing the aqueous solvent, moisture, or water from the polymeric system (e.g., drying, heating, etc.) may trigger or activate the latent acid catalyst to release the acid species, thereby curing and/or crosslinking the polymeric system and/or a component (e.g., curable latex polymeric binder) thereof. The latent acid catalyst may be capable of or configured to facilitate or react directly to cure and/or crosslink, substantially cure and/or crosslink, or at least partially cure and/or crosslink the polymeric system and/or a component thereof at about room temperature (e.g., about 20° C. to about 30° C.). In one example, the latent acid catalyst may be capable of or configured to react with carboxyl groups of the polymeric system or the curable latex polymeric binder thereof, thereby forming covalent links, bridges, and/or crosslinks therein. In another example, the latent acid catalyst may be capable of or configured to facilitate the formation of bridges or covalent links between polymer chains of the polymeric system via respective carboxyl groups thereof. The latent acid catalyst may also be capable of or configured to improve water resistance and/or wet strength of the cured polymeric system without aging (e.g., online or offline oven aging). Without being bound by theory, it is believed that the reaction between the latent acid catalyst and the carboxyl groups of the curable latex polymeric binder may increase water resistance and/or wet strength (e.g., wet tensile strength) of the resulting polymer reinforced materials, even without oven aging (e.g., online or offline aging). The wet tensile test is measured after a 20 minute soak in distilled water with 1% Triton X-100 surfactant and the test is conducted the same as TAPPI T 456 om-22.

Illustrative accelerants or latent acid catalysts may be or include, but are not limited to, one or more of a triphenylsulfonium salt (TPS), diarylidonium salt, ammonium salts, cationic sulfonium and iodonium salts, epoxy-functionalized organosilane compounds, phenyl sulfonic acid esters, methanesulfonic acid derivatives, toluene sulfonic acid esters, or the like, or any combination thereof. Illustrative ammonium salts may be or include, but are not limited to, one or more of an ammonium salt of a polycarboxylic acid, ammonium citrate, ammonium hydrogen maleate, ammonium malate, ammonium oxalate, ammonium peroxydisulphate, ammonium phosphate, ammonium sulphate, ammonium chloride, ammonium thiocyanate, C₁-C₄-alkylammonium salts of carboxylic acids, methylammonium phthalate, methylammonium maleate, hydrates thereof, or the like, or any combination thereof. Illustrative accelerants or latent acid catalysts may also include, but are not limited to, one or more of methylamine salt of naphthalenesulphonic acid; esters of phosphoric acid, phosphorous acid, oxalic acid and/or phthalic acid, in particular diethyl phosphate, oxalic acid dimethyl ester and/or phthalic acid dimethyl ester, or the like, or any combination thereof. In an exemplary implementation, the accelerants or latent acid catalyst may include one or more ammonium salts, such as ammonium oxalate or dry ammonium oxalate. Ammonium oxalate ([NH₄]₂C₂O₄; MW=124.096 g/mol) is an ammonium salt of oxalic acid that is capable of or configured to release oxalic acid. Ammonium oxalate may be capable of or configured to release oxalic acid upon drying of the polymeric system or a component thereof. For example, the polymeric system may be an aqueous solution including ammonium oxalate as the accelerant, and upon drying of the polymeric system the ammonium oxalate may release oxalic acid to thereby initiate curing and/or crosslinking of the polymeric system or the curable latex polymeric binder thereof. The ammonium oxalate may be configured to release oxalic acid upon drying to less than or equal to about 5% moisture/water, less than or equal to about 4% moisture/water, less than or equal to about 3% moisture/water, less than or equal to about 2% moisture/water, less than or equal to about 1% moisture/water, less than or equal to about 0.5% moisture/water, or less than or equal to about 0.1% moisture/water.

The accelerants or latent acid catalysts may be present in the polymeric system (e.g., the saturating composition) in an amount of from about 0.1 wt % to about 10 wt %, or about 0.5 wt. % to about 5 wt. %, or about 1 wt. % to about 3 wt. %, or about 2 wt. % to about 2.5 wt. % based on the total dry weight of the saturating composition. For example, the accelerant may be present in the polymeric system in an amount of from about 0.1 wt %, about 0.5 wt %, about 1 wt %, about 2 wt %, about 3 wt %, about 4 wt %, or about 5 wt % to about 6 wt % about 7 wt %, about 8 wt %, about 9 wt %, or about 10 wt %, based on the total dry weight of the saturating composition. In an exemplary implementation, the one or more accelerants or latent acid catalysts may be present in an amount of from about 1 wt % to about 4 wt %, about 2 wt % to about 3 wt %, or about 2 wt %, based on the total dry weight of the saturating composition. It should be appreciated that the amount of the accelerants may be determined, at least in part, on the amount of carboxyl groups or the degree of carboxylation of the curable latex polymeric binder.

The polymer reinforced materials may have a relatively greater ratio of wet tensile strength to dry tensile strength (i.e., ratio of wet/dry tensile strength) as compared to a conventional polymer reinforced materials excluding the accelerant, where the conventional polymer reinforced materials may be aged or unaged. Wet tensile strength and dry tensile strength may be determined according to any one or more reference tests of the Technical Association of the Pulp and Paper Industry, Inc. (TAPPI), such as TAPPI T456.

In at least one implementation, the polymer reinforced materials may have a ratio of wet/dry tensile strength of greater than or equal to about 50%, greater than or equal to about 52%, greater than or equal to about 54%, greater than or equal to about 56%, greater than or equal to about 58%, greater than or equal to about 60%, greater than or equal to about 62%, greater than or equal to about 64%, greater than or equal to about 66%, greater than or equal to about 68%, greater than or equal to about 70%, greater than or equal to about 72%, greater than or equal to about 74%, or greater. In at least one implementation, the polymer reinforced materials may have a ratio of wet/dry tensile strength of greater than or equal to about 50%, and less than or equal to about 100%, less than or equal to about 90%, less than or equal to about 80%, less than or equal to about 78%, less than or equal to about 76%, less than or equal to about 74%, less than or equal to about 72%, less than or equal to about 70%, less than or equal to about 68%, less than or equal to about 66%, less than or equal to about 64%, or less.

The polymer reinforced materials may have a machine direction (MD) wet tensile strength of from about 5 kilograms/15 millimeters (kg/15 mm) to about 10 kg/15 mm or about 6 kilograms/15 millimeters to about 9 kilograms/15 millimeters, or about 7 kilograms/15 millimeters. For example, the polymer reinforced materials may have a MD wet tensile strength of from about 5 kg/15 mm, about 6 kg/15 mm, about 7 kg/15 mm, about 8 kg/15 mm, about 9 kg/15 mm, or about 10 kg/15 mm.

The polymer reinforced materials may have a machine direction (MD) dry tensile strength of from about 10 kilograms/15 millimeters (kg/15 mm) to about 15 kg/15 mm. For example, the polymer reinforced materials may have a MD dry tensile strength of from about 10 kg/15 mm, about 11 kg/15 mm, about 12 kg/15 mm, about 13 kg/15 mm, about 14 kg/15 mm, or about 15 kg/15 mm.

The polymeric system may include the one or more crosslinkers, if present, and the one or more accelerants in a dry weight ratio (e.g., bone dry weight ratio) of from about 5:1 (i.e., about 5 to about 1) to about 1:5. For example, the polymeric system may include the crosslinker and the accelerant in a dry weight ratio of from about 5:1, about 4:1, about 3:1, about 2:1, about 1.5:1, or about 1:1 to about 1:1.5, about 1:2, about 1:3, about 1:4, or about 1:5. In an exemplary implementation, the polymeric system may include the crosslinker and the accelerant in a dry weight ratio of from about 2:1 to about 1:2, about 1.5:1 to about 1:1.5, or about 1:1.

In at least one implementation, the polymeric system may include one or more film forming resins, such as, one or more styrene maleic anhydride (SMA) copolymers. The film forming resins may be capable of or configured to improve adhesion of the polymeric system, enhance strength (e.g., mechanical strength) of the resulting cured latex polymer, facilitate or promote dispersion of one or more components of the polymeric system, facilitate or enhance film-forming properties of the polymeric system, modify one or more surface characteristics or properties of the polymer reinforced materials, improve water resistance, or any combination thereof. For example, the SMA copolymers may be capable of or configured to improve rigidity, toughness, chemical resistance, or any combination thereof of the cured polymeric system, the latex polymer thereof, or the polymer reinforced materials. The SMA copolymer may also be configured to improve bonding of the polymeric system to substrates, such as the base. As used herein, the term or expression “styrene maleic anhydride copolymer” or the like may refer to a polymer obtained by copolymerization of one or more maleic anhydride comonomers and one or more styrene comonomers.

The polymeric system may also include one or more additional components including, but not limited to, one or more of an antioxidant, particles, fillers, emulsifying agents, pH adjustment agents, surfactants, thickening agents, or the like, or any combination thereof. Any one or more of the additional components may be present in the polymeric system in an amount of from about greater than 0 wt % to less than or equal to about 10 wt %, less than or equal to about 9 wt %, less than or equal to about 8 wt %, less than or equal to about 7 wt %, less than or equal to about 5 wt %, based on the total weight of the polymeric system. The antioxidants may be capable of or configured to inhibit oxidation. Illustrative antioxidants may be or include, but are not limited to, one or more of substituted phenolic compounds such as butylated dihydroxyanisole, di-tert-butyl-p-cresol, propyl gallate, aromatic amines, such as, di-beta-naphthyl-para-phenylenediamine, phenyl-heta-naphthylamine, or the like, or any combination thereof. Illustrative particles may be or include, but are not limited to, one or more of silica, silicates, clays, borates, or the like, or any combination thereof.

In at least one implementation, the polymer reinforced materials may include an abrasive coating. For example, the abrasive coating may be applied to the polymer reinforced materials to prepare sandpaper. The abrasive coating may include abrasive particles or materials dispersed in an adhesive material or composition. Any known abrasive particles/materials and adhesives may be utilized.

Methods for preparing the polymer reinforced materials may include, in no particular order, preparing a base (e.g., paper or base making), preparing the polymeric system or the saturating composition, a saturation process that may include contacting the base with the polymeric system to prepare a coated base, aging the coated base, calendering/rewinding the coated base, or any combination thereof. For example, the method for preparing the polymer reinforced materials may include preparing the base, contacting the base with the polymeric system to prepare the coated base, aging the coated vase to prepare a coated and aged base, and calendering/rewinding the coated and aged base. In another example, the method for preparing the polymer reinforced materials may include preparing the base, contacting the base with the polymeric system to prepare the coated base, and calendering/rewinding the coated base. In an exemplary implementation, the method may exclude aging. For example, as further described herein, the method may exclude online aging, offline aging, or a combination thereof. As used herein, the term “aging” refers to thermal aging, such as thermal aging via an oven. Thermal aging may include heating to a temperature greater than or equal to about 95° C., greater than or equal to about 98° C., greater than or equal to about 99° C., greater than or equal to about 100° C., greater than or equal to about 110° C., or greater.

The method for preparing the polymer reinforced materials may include one or more online steps or processes, one or more offline steps or processes, or a combination thereof. As used herein, the term or expression “online process” or the like (e.g., inline process) refers to a process/step that occurs during the production process where the respective process/step is integrated into the processing machine itself. As used herein, the term or expression “offline process” or the like refers to a process/step that occurs after completion of the production process. In at least one implementation, any one or more of the online processes may include preparing the base, contacting the base with the polymeric system to prepare the coated base, aging the coated base, calendering/rewinding the coated base, or any combination thereof. For example, the online processes for preparing the polymer reinforced materials may include preparing the base, contacting the base with the polymeric system to prepare the coated base, aging the coated base, and calendering/rewinding the coated and aged base. In another example, the online processes for preparing the polymer reinforced materials may include preparing the base, contacting the base with the polymeric system to prepare the coated base, and calendering/rewinding the coated base, and may further exclude online aging. In at least one implementation, the method may include offline aging. For example, the method may include aging after preparation of the polymer reinforced materials. In another example, the method may include drying the coated base online. In an exemplary implementation, the method for preparing the polymer reinforced materials may exclude online aging. It should be appreciated that excluding online aging may reduce energy requirements for preparing the polymer reinforced materials. In at least one implementation, the method may include curing the polymeric system online via drying and exclude crosslinking the polymeric system online. For example, the method may include drying the polymeric system (i.e., the saturating composition) of the coated base online and crosslinking the polymeric system of the coated base offline. In at least one example, the polymeric reinforced materials may be prepared without online aging. In at least one example, the polymeric reinforced materials may be prepared only with offline aging and without online aging. In another example, the polymeric reinforced materials may be prepared without online or offline aging. In yet another example, the polymeric reinforced materials may be cured and/or crosslinked at room temperature.

The saturation process, or contacting the base with the polymeric system (e.g., the saturating composition) to prepare the coated base, may include any conventional saturation technique including, but not limited to, brushing, flooded nip saturation, doctor blading, spraying, direct and offset gravure coating, or the like, or any combination thereof. The amount of the polymeric system applied to the base may vary and may depend, at least in part, on one or more desired properties of the resulting polymer reinforced materials, such as permeability, wet strength, dry strength, or the like, or any combination thereof.

Calendering and/or rewinding may increase the softness and/or smoothness of the polymer reinforced materials. Calendering may generally include pressing the coated base in a nip formed by a first and/or second calendering rolls. Suitable calendering pressures may be from about 50 to about 2000 pounds-force per linear inch (pli), from about 100 to about 1600 pli, from about 300 to about 1000 pli, or from about 400 to about 600 pli. Suitable calendering temperatures may be from about 20° C. to about 240° C., from about 20° C. to about 140° C., from about 20° C. to about 100° C., from about 50° C. to less than or equal to about 100° C. Calendering may be an online process.

The coated base or the base saturated with the polymeric system, whether calendered or not calendered, may be dried to remove the solvent from the polymeric system (i.e., the saturating composition). In at least one example, curing may include drying the polymeric system coated or otherwise contacted with the base. Drying may include, but is not limited to, heating with a conventional oven, forced air, heated roll, thru-air drying, or the like, or any combination thereof. In at least one implementation, drying the coated base may initiate curing and/or crosslinking of the polymeric system. For example, drying the coated base may initiate the release of an acid species from the accelerant of the polymeric system to thereby facilitate the curing or crosslinking of the curable latex polymeric binder. In one example, drying may exclude online aging. Drying or curing the coated base may include drying the polymeric system or the curable latex polymeric binder thereof to less than or equal to about 5% moisture/water, less than or equal to about 4% moisture/water, less than or equal to about 3% moisture/water, less than or equal to about 2% moisture/water, less than or equal to about 1% moisture/water, less than or equal to about 0.5% moisture/water, or less than or equal to about 0.1% moisture/water.

In an exemplary implementation, the method for preparing the polymer reinforced materials may not include any added heat for aging during any online and/or offline process. For example, the method may include preparing the base online, preparing the polymeric system, online saturation by contacting the base with the polymeric system, online calendering with heat, and offline aging, where offline aging may not include introducing additional heat (e.g., via oven). For example, the offline aging may include only the heat from an online process, such as the online calendering process. Accordingly, in one example, the only heat in the calendered base may be from the online process. In another example, the method may include offline aging with heat added (e.g., via oven). For example, the method may include heating after the final or last online process. For example, the method may include heating after calendaring the coated base and/or after curing (e.g., drying) the coated base.

In at least one implementation, the method may include contacting the polymer reinforced materials with a top coating. Illustrative top coatings may be or include, but are not limited to, one or more of a film forming coating, a barrier coating, a semi-porous coating, or the like, or any combination thereof.

In at least one implementation, the method may include applying the abrasive coating to the polymer reinforced materials. The abrasive coating may be applied after saturation. The abrasive coating may be applied before or after applying the top coatings. The abrasive coating may be applied before or after calendering.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary polymer reinforced materials (1)-(6) were prepared and evaluated.

A first polymer reinforced material (1) was prepared by permeating a textile with a saturating composition, and aging the saturated textile in an oven maintained at about 112.7° C. for about 180 min. The textile had a basis weight of about 145 gsm. Typical size press configurations for saturating a sheet are described by Smook (Smook, G. A., Handbook for Pulp and Paper Technologists, Ch. 18-Surface Treatments, p. 263, 1989). The saturating composition for the first polymer reinforced material (1) included a styrene acrylic curable latex as well as an SBR latex. The first polymer reinforced material (1) was aged at about 235° F. for about 3 hours.

A second polymer reinforced material (2) was prepared by permeating or impregnating a textile with a saturating composition. It should be noted that the second polymer reinforced material (2) was not oven aged, as compared to the first polymer reinforced material (1). The textile had a basis weight of about 145 gsm. The saturating composition for the second polymer reinforced textile (2) included both an accelerant, and a crosslinker. Specifically, the accelerant was ammonium oxalate (C₂H₈N₂O₄) and the crosslinker was the epoxide Epi-Rez 3510.

The third polymer reinforced material (3) was prepared by permeating or impregnating a textile with a saturating composition without aging in the oven. The textile was an uncoated textile having a basis weight of about 118 gsm. The saturating composition included two polymers, namely, a styrene butadiene rubber (SBR) latex and a styrene acrylic latex. The saturating composition also included an anionic-nonionic emulsifier system and was stabilized with an antioxidant.

The fourth polymer reinforced material (4) was the same as the third polymer reinforced material (3), however, the fourth polymer reinforced material (4) was aged in an oven maintained at about 112.7° C. for about 180 min.

The fifth polymer reinforced material (5) was prepared by permeating or impregnating a textile with a saturating composition with aging in the oven. The textile had a basis weight of about 145 gsm. The saturating composition for the fifth polymer reinforced material (5) included an NBR latex polymer, an accelerant, and a crosslinker. The fifth polymer reinforced material (5) was oven aged at about 235° F. for about 3 hours.

The sixth polymer reinforced material (6) was prepared by contacting or coating a textile with a saturating composition without aging in the oven. The textile had a basis weight of about 145 gsm. The saturating composition for the sixth polymer reinforced material (6) included two latex polymers, an accelerant, and a crosslinker.

TABLE 1
Composition of Saturant for Polymer Reinforced Materials (1)-(6)

| | | (2) | | (4) | (5) | |
|---|---|---|---|---|---|---|
| | (1) | w/accelerant | (3) | w/aged | std | |
| | Sto | and xlinker | Std →(4) | base | (NBR) | (6) |
| Formula i.d. | A | B | C | D | E | D |
| Formula | SF1375.1 | SF1375.2 | SF1397.1 | SF1397.1 | SF1073.1 | SF1397.2 |
| Reference | | | | | | |
| Run Date | Sep. 20, 2023 | Sep. 20, 2023 | May 31, 2023 | May 31, 2023 | Standard | Apr. 22, 2024 |
| | and | and | | and | Product | and |
| | Sep. 29, 2023 | Sep. 29, 2023 | | Sep. 23, 2023 | | Apr. 30, 2024 |
| SBR Curable | 62.46 | 59.47 | 67.87 | 67.87 | 0 | 64.38 |
| Latex | | | | | | |
| (wt. %) | | | | | | |
| NBR Curable | 0 | 0 | 0 | 0 | 85.21 | 0 |
| Latex | | | | | | |
| (wt. %) | | | | | | |
| Styrene | 20.82 | 19.82 | 22.62 | 22.62 | 0 | 21.46 |
| Acrylic | | | | | | |
| Curable latex | | | | | | |
| (wt. %) | | | | | | |
| Epi-Rez 3510 | 0 | 2.38 | 0 | 0 | 0 | 2.58 |
| Crosslinker | | | | | | |
| (wt. %) | | | | | | |
| Ammonium | 0 | 2.38 | 0 | 0 | 0 | 2.58 |
| Oxalate | | | | | | |
| Accelerant | | | | | | |
| (wt. %) | | | | | | |
| Other Minor | 16.74 | 16.01 | 9.57 | 9.57 | 14.79 | 9.08 |
| Additives | | | | | | |
| Final | 147.4 | 147.4 | 118.4 | | 147.4 | 147.4 |
| Conditioned | | | | | | |
| Basis Weight | | | | | | |
| of Textile | | | | | | |
| (gsm) | | | | | | |

TABLE 2
Summary of Conditions and Results for
Polymer Reinforced Materials (1)-(6)

| | | (2) | | | (5) | |
|---|---|---|---|---|---|---|
| | (1) | w/accelerant | (3) | (4) | std | |
| | Std | and xlinker | Std | aged | (NBR) | (6) |
| Oven Aged | Yes | No | No | Yes | Yes | No |
| Time of Aging | 3 | 0 | 0 | 3 | 3 | 0 |
| (hours) | | | | | | |
| MD Wet Tensile | 5.37 | 7.1 | 3.2 | 5.6 | 5.99 | 5.5 |
| (kg/15 mm) | | | | | | |
| MD Dry Tensile | 10.5 | 10.5 | 10.5 | 13.2 | 12.5 | 12.9 |
| (kg/15 mm) | | | | | | |
| Ratio of Wet/Dry | 51.1 | 67.6 | 30.5 | 42.4 | 47.9 | 42.6 |
| Tensile Strength | | | | | | |
| (%) | | | | | | |

As indicated in Table 2, the polymer reinforced material (2), which was not oven aged, exhibited a wet MD tensile strength of about 7.1 kg/15 mm, which was about 32% greater than the polymer reinforced material (1), which was oven aged. The wet tensile strength of the polymer reinforced material (2) was also about 26% greater than the polymer reinforced material (4).

As further indicated in Table 2, the polymer reinforced material (2), which was not oven-aged, exhibited a relatively greater ratio of wet/dry tensile strength than the polymer reinforced material (1), which was oven-aged. Specifically, the polymer reinforced material (2) had a wet/dry tensile strength of about 67.6%, as compared to 51.1%. The polymer reinforced material (2) also exhibited relatively greater wet/dry tensile strength as compared to the polymer reinforced material (5), which utilized NBR latex.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

For example, a first embodiment is a composite material, comprising: a base comprising one or more layers; and a crosslinked latex polymer disposed on the base, the crosslinked latex polymer being prepared from a saturating composition comprising an aqueous solvent, a curable latex polymer, and an accelerant, and wherein the accelerant comprises a latent acid catalyst.

A second embodiment is the first embodiment, wherein the crosslinked latex polymer is prepared by crosslinking the curable latex polymer with the latent acid catalyst.

A 3^{rd} embodiment is any combination of the above embodiments, wherein the saturating composition further comprises a crosslinker.

A 4^{th} embodiment is any combination of the above embodiments, wherein the crosslinked latex polymer is prepared by activating the latent acid catalyst to release an acid species; and crosslinking the curable latex polymer with the acid species from the latent acid catalyst.

A 5^{th} embodiment is any combination of the above embodiments, wherein activating the latent acid catalyst to release the acid species comprises drying the saturating composition such that the saturating composition comprises less than or equal to about 15 wt. % to about 40% of the aqueous solvent, based on the total weight of the composite material.

A 6^{th} embodiment is any combination of the above embodiments, wherein crosslinking the curable latex polymer does not comprise thermal aging.

A 7^{th} embodiment is any combination of the above embodiments, wherein crosslinking the curable latex polymer does not comprise online thermal aging.

An 8^{th} embodiment is any combination of the above embodiments, wherein crosslinking the curable latex polymer does not comprise offline thermal aging.

A 9^{th} embodiment is any combination of the above embodiments, wherein crosslinking the curable latex polymer comprises offline thermal aging.

A 10^{th} embodiment is any combination of the above embodiments, wherein the base comprises a basis weight of from about 50 grams per square meter (gsm) to about 200 gsm.

An 11th embodiment is any combination of the above embodiments, wherein the base comprises a thickness of from about 0.05 mm to about 1 mm.

A 12^{th} embodiment is any combination of the above embodiments, wherein the curable latex polymer comprises a polyvinyl acetate latex, a nitrile butadiene rubber (NBR) latex, a styrene butadiene rubber (SBR) latex, a styrene acrylic latex or a combination thereof.

A 13th embodiment is any combination of the above embodiments, wherein the curable latex polymer comprises a styrene acrylic latex and a styrene butadiene rubber (SBR).

A 14^{th} embodiment is any combination of the above embodiments, wherein the styrene acrylic latex is present in about 10 wt. % to about 30 wt. % of the saturating composition.

A 15th embodiment is any combination of the above embodiments, wherein the styrene acrylic latex is present in about 20 wt. % to about 22 wt. % of the saturating composition.

A 16th embodiment is any combination of the above embodiments, wherein the styrene butadiene rubber (SBR) is present in about 50 wt. % to about 90 wt. % of the saturating composition.

A 17^{th} embodiment is any combination of the above embodiments, wherein the styrene butadiene rubber (SBR) is present in about 60 wt. % to about 65 wt. % of the saturating composition.

An 18^{th} embodiment is any combination of the above embodiments, wherein the curable latex polymer comprises a plurality of polymer chains, each of the plurality of polymer chains comprising a plurality of carboxyl functional groups.

A 19^{th} embodiment is any combination of the above embodiments, wherein the latent acid catalyst is configured to facilitate the formation of crosslinks between respective carboxyl functional groups of each of the plurality of polymer chains.

A 20^{th} embodiment is any combination of the above embodiments, wherein the latent acid catalyst comprises an ammonium salt.

A 21^{st} embodiment is any combination of the above embodiments, wherein the ammonium salt comprises ammonium oxalate.

A 22^{nd} embodiment is any combination of the above embodiments, wherein the latent acid catalyst is present in an amount of from about 0.1 wt. % to about 10 wt. %, based on the total dry weight of the saturating composition.

A 23^{rd} embodiment is any combination of the above embodiments, wherein the latent acid catalyst is present in an amount of from about 1 wt. % to about 3 wt. %, based on the total dry weight of the saturating composition.

A 24^{th} embodiment is any combination of the above embodiments, wherein the composite material comprises a machine direction wet tensile strength of from about 5 kilograms/15 millimeters (kg/15 mm) to about 10 kg/15 mm.

A 25^{th} embodiment is any combination of the above embodiments, wherein the composite material comprises a machine direction dry tensile strength of from about 10 kilograms/15 millimeters (kg/15 mm) to about 15 kg/15 mm.

A 26^{th} embodiment is any combination of the above embodiments, wherein the composite material comprises ratio of wet tensile strength to dry tensile strength of greater than or equal to about 50%.

A 27^{th} embodiment is any combination of the above embodiments, wherein the saturating composition further comprises a film forming resin.

A 28^{th} embodiment is composite material, comprising: a base comprising one or more layers; and a crosslinked latex polymer disposed on the base, wherein the composite material is prepared by: disposing a saturating composition on the base, the saturating composition comprising an aqueous solvent, a curable latex polymer, and an accelerant, wherein the accelerant comprises a latent acid catalyst; drying the saturating composition disposed on the base to activate the accelerant to release an acid species; and crosslinking the curable latex polymer with the acid species to prepare the composite material.

A 29^{th} embodiment is the 28^{th} embodiment and any combination of the above embodiments.

A 30^{th} embodiment is any combination of the above embodiments, wherein the saturating composition further comprises a crosslinker.

A 31^{st} embodiment is any combination of the above embodiments, wherein drying the saturating composition comprises drying the saturating composition to less than or equal to about 15 wt. % to about 40 wt. % of the aqueous solvent, based on the total weight of the composite material.

A 32^{nd} embodiment is any combination of the above embodiments, wherein crosslinking the curable latex polymer with the acid species does not comprise thermal aging.

A 33^{rd} embodiment is any combination of the above embodiments, wherein crosslinking the curable latex polymer with the acid species does not comprise online thermal aging.

A 34^{th} embodiment is any combination of the above embodiments, wherein crosslinking the curable latex polymer with the acid species does not comprise offline thermal aging.

A 35^{th} embodiment is any combination of the above embodiments, wherein crosslinking the curable latex polymer with the acid species comprises offline thermal aging.

A 36^{th} embodiment is any combination of the above embodiments, wherein the base comprises a basis weight of from about 50 grams per square meter (gsm) to about 200 gsm.

A 37^{th} embodiment is any combination of the above embodiments, wherein the base comprises a thickness of from about 0.05 mm to about 1 mm.

A 38^{th} embodiment is any combination of the above embodiments, wherein the curable latex polymer comprises a polyvinyl acetate latex, a nitrile butadiene rubber (NBR) latex, a styrene butadiene rubber (SBR) latex, or a combination thereof.

A 39^{th} embodiment is any combination of the above embodiments, wherein the curable latex polymer comprises a plurality of polymer chains, each of the plurality of polymer chains comprising a plurality of carboxyl functional groups.

A 40^{th} embodiment is any combination of the above embodiments, wherein the latent acid catalyst is configured to facilitate the formation of crosslinks between respective carboxyl functional groups of each of the plurality of polymer chains.

A 41^{st} embodiment is any combination of the above embodiments, wherein the latent acid catalyst comprises an ammonium salt.

A 42^{nd} embodiment is any combination of the above embodiments, wherein the ammonium salt comprises ammonium oxalate.

A 43^{rd} embodiment is any combination of the above embodiments, wherein the accelerant is present in an amount of from about 0.1 wt. % to about 10 wt. %, based on the total dry weight of the saturating composition.

A 44^{th} embodiment is any combination of the above embodiments, wherein the composite material comprises a machine direction wet tensile strength of from about 5 kilograms/15 millimeters (kg/15 mm) to about 10 kg/15 mm.

A 45^{th} embodiment is any combination of the above embodiments, wherein the composite material comprises a machine direction dry tensile strength of from about 10 kilograms/15 millimeters (kg/15 mm) to about 15 kg/15 mm.

A 46^{th} embodiment is any combination of the above embodiments, wherein the composite material comprises ratio of wet tensile strength to dry tensile strength of greater than or equal to about 50%.

A 47^{th} embodiment is any combination of the above embodiments, wherein the saturating composition further comprises a film forming resin.

A 48^{th} embodiment is any combination of the above embodiments, wherein the film forming resin comprises one or more styrene maleic anhydride (SMA) polymers.

A 49^{th} embodiment is a composite material, comprising: a base comprising one or more layers; and a crosslinked latex polymer disposed on the base, the crosslinked latex polymer comprising a reaction product of a curable latex polymeric and an acid species derived from a latent acid catalyst.

A 50^{th} embodiment is the 49^{th} embodiment and any combination of the above embodiments.

A 51^{st} embodiment is any combination of the above embodiments, wherein the latent acid catalyst comprises an ammonium salt.

A 52^{nd} embodiment is any combination of the above embodiments, wherein the latent acid catalyst comprises ammonium oxalate, and wherein the acid species comprises oxalic acid.

A 53^{rd} embodiment is any combination of the above embodiments, wherein the oxalic acid facilitates the crosslinking of the plurality of polymer chains with one another.

A 54^{th} embodiment is any combination of the above embodiments, wherein the latent acid catalyst is present in an amount of from about 0.1 wt. % to about 10 wt. %, based on the total dry weight of the saturating composition.

A 55^{th} embodiment is any combination of the above embodiments, wherein the latent acid catalyst is present in an amount of from about 1 wt. % to about 3 wt. %, based on the total dry weight of the saturating composition.

A 56^{th} embodiment is any combination of the above embodiments, wherein the curable latex polymer comprises a polyvinyl acetate latex, a nitrile butadiene rubber (NBR) latex, a styrene butadiene rubber (SBR) latex, a styrene acrylic latex or a combination thereof.

A 57^{th} embodiment is any combination of the above embodiments, wherein the curable latex polymer comprises a styrene acrylic latex and a styrene butadiene rubber (SBR).

A 58^{th} embodiment is any combination of the above embodiments, wherein the styrene acrylic latex is present in about 10 wt. % to about 30 wt. % of the saturating composition.

A 59^{th} embodiment is any combination of the above embodiments, wherein the styrene acrylic latex is present in about 20 wt. % to about 22 wt. % of the saturating composition.

A 60^{th} embodiment is any combination of the above embodiments, wherein the styrene butadiene rubber (SBR) is present in about 50 wt. % to about 90 wt. % of the saturating composition.

A 61^{st} embodiment is any combination of the above embodiments, wherein the styrene butadiene rubber (SBR) is present in about 60 wt. % to about 65 wt. % of the saturating composition.

A 62^{nd} embodiment is an abrasive product comprising any combination of the above embodiments.

A 63^{rd} embodiment is any combination of the above embodiments, wherein the abrasive product is sandpaper.

A 64^{th} embodiment is a label comprising any combination of the above embodiments.

What is claimed is:

1. A composite material, comprising:
a base comprising one or more layers; and
a crosslinked latex polymer disposed on the base, the crosslinked latex polymer being prepared from a saturating composition comprising an aqueous solvent, a curable latex polymer, and an accelerant, and
wherein the accelerant comprises a latent acid catalyst.

2. The composite material of claim 1, wherein the saturating composition further comprises a crosslinker.

3. The composite material of claim 1, wherein the base comprises a basis weight of from about 50 grams per square meter (gsm) to about 200 gsm.

4. The composite material of claim 1, wherein the base comprises a thickness of from about 0.05 mm to about 1 mm.

5. The composite material of claim 1, wherein the curable latex polymer comprises a nitrile butadiene rubber (NBR) latex, a styrene butadiene rubber (SBR) latex, a styrene acrylic latex or a combination thereof.

6. The composite material of claim 1, wherein the curable latex polymer comprises a styrene acrylic latex and a styrene butadiene rubber (SBR).

7. The composition of claim 6, wherein the styrene acrylic latex is present in about 10 wt. % to about 30 wt. % of the saturating composition.

8. The composition of claim 6, wherein the styrene butadiene rubber (SBR) is present in about 50 wt. % to about 90 wt. % of the saturating composition.

9. The composite material of claim 1, wherein the curable latex polymer comprises a plurality of polymer chains, each of the plurality of polymer chains comprising a plurality of carboxyl functional groups.

10. The composite material of claim 1, wherein the latent acid catalyst comprises an ammonium salt.

11. The composite material of claim 1, wherein the latent acid catalyst is present in an amount of from about 0.1 wt % to about 10 wt %, based on the total dry weight of the saturating composition.

12. The composite material of claim 1, wherein the saturating composition further comprises a film forming resin.

13. A composite material, comprising:
a base comprising one or more layers; and
a crosslinked latex polymer disposed on the base, the crosslinked latex polymer comprising a reaction product of a curable latex polymeric and an acid species derived from a latent acid catalyst.

14. The composite material of claim 13, wherein the latent acid catalyst comprises an ammonium salt.

15. The composite material of claim 13, wherein the latent acid catalyst comprises ammonium oxalate, and wherein the acid species comprises oxalic acid.

16. The composite material of claim 13, wherein the latent acid catalyst is present in an amount of from about 0.1 wt. % to about 10 wt. %, based on the total dry weight of the saturating composition.

17. The composite material of claim 13, wherein the curable latex polymer comprises a polyvinyl acetate latex, a nitrile butadiene rubber (NBR) latex, a styrene butadiene rubber (SBR) latex, a styrene acrylic latex or a combination thereof.

18. The composite material of claim 13, wherein the curable latex polymer comprises a styrene acrylic latex and a styrene butadiene rubber (SBR).

19. The composition of claim 18, wherein the styrene acrylic latex is present in about 10 wt. % to about 30 wt. % of the saturating composition.

20. The composition of claim 13, wherein the styrene butadiene rubber (SBR) is present in about 50 wt. % to about 90 wt. % of the saturating composition.
